(19) United States
(12) Patent Application Publication
(10) Pub. No.: US 2025/0382804 A1
(43) Pub. Date: Dec. 18, 2025

(54) DIRECT DRIVE HAPTIC FLOOR SYSTEM HAVING OPTICAL FLOOR TILES

(71) Applicant: STRONG/MDI SCREEN SYSTEMS, INC., Joliette (CA)

(72) Inventors: Dustin SMALL, Kissimmee, FL (US); Guillaume Henri-Luc Marie DAVID, Montréal (CA)

(21) Appl. No.: 18/742,503

(22) Filed: Jun. 13, 2024

(51) Int. Cl. E04F 15/024; B06B 1/02; E04F 15/22; G03B 21/60

(52) U.S. Cl. CPC E04F 15/02458; B06B 1/02; E04F 15/02405; E04F 15/0247; E04F 15/02494; E04F 15/225; G03B 21/60; E04F 2290/00

(57) ABSTRACT

A direct drive haptic floor system includes a plurality of dynamic floor assemblies configured to be spaced apart on a floor surface. Each of the plurality of dynamic floor assemblies comprises a substructure, an actuator secured to the substructure and configured to vibrate, and a plurality of connectors secured to the substructure and configured for elevating the substructure above the floor surface. The dynamic floor assemblies also include a plurality of bushings secured between the plurality of connectors and the substructure, a plurality of adjustable levelers extending from a top portion of the substructure, and a superstructure supported by the plurality of adjustable levelers. A plurality of structural panels are secured on top of the superstructure forming a planar surface, and a plurality of optical floor tiles are removably secured over the plurality of structural panels using magnetic forces.

### TECHNICAL FIELD

The present invention relates to the field of immersive entertainment systems, and, more particularly, to a direct drive haptic floor system having optical floor tiles.

### BACKGROUND

A haptic floor is an interactive technology designed to provide tactile feedback through the floor surface. The floor uses various mechanisms such as actuators, vibrators, or pressure plates to create sensations that can be felt by people walking or standing on the floor. The actuators are embedded in the floor and produce vibrations or movements. They can vary in type, including piezoelectric actuators, pneumatic actuators, or electromagnetic actuators. The floor may also include sensors to detect the presence and movement of individuals. This allows the floor to respond dynamically to the user's location and actions.

A central control unit typically processes input from the sensors and sends signals to the actuators to create the desired haptic feedback. The haptic floor can be programmed to generate various patterns and intensities of feedback.

In addition, the haptic floor can generate different types of tactile feedback, such as vibrations, pressure changes, or movement simulations. These patterns can be used to guide, inform, or entertain users. Haptic floors can be used in virtual reality (VR) and in gaming, for example. The haptic floor enhances the immersive experience by simulating different terrains or events, such as walking on gravel or feeling an earthquake.

Overall, haptic floors can enhance user interaction with their environment through tactile feedback, offering a wide range of applications from practical navigation aids to immersive entertainment experiences. However, there is a need in the art for a haptic floor that is high performance, silent, flexibility of independent zones, projectability, maintenance and heavy equipment friendly, adaptable to unique venues and or environments and can handle increased loading capacity via large groups of people.

### SUMMARY

In view of the foregoing background, it is therefore an object of the present invention to provide a haptic floor system that is high quality while being easy to install, maintain, and is cost effective. This and other objects, features, and advantages in accordance with the present invention are provided by a direct drive haptic floor system. The system includes a plurality of dynamic floor assemblies configured to be spaced apart on a floor surface. Each of the plurality of dynamic floor assemblies includes a substructure, an actuator secured to the substructure and configured to vibrate, and a plurality of connectors secured to the substructure and configured for elevating the substructure above the floor surface. The system also includes a plurality of bushings secured between the plurality of connectors and the substructure. The plurality of bushings are configured to constrain movement of the substructure in response to operation of the actuator. In addition, the system includes a plurality of adjustable levelers extending from a top portion of the substructure, a superstructure supported by the plurality of adjustable levelers, and a plurality of structural panels secured on top of the superstructure forming a planar surface. A plurality of optical floor tiles are removably secured over the plurality of structural panels using magnetic forces. Each optical floor tile may include a top projection layer, a core layer, and a magnetic layer laminated together.

The system may include a plurality of structural bridge panels bridging a gap between two dynamic floor assemblies, where the structural bridge panels have a first edge supported by a superstructure of a first dynamic floor assembly and a second opposing edge supported by a second dynamic floor assembly. The plurality of structural panels are ferromagnetic so that the magnetic optical floor tiles can be secured thereto using magnetic forces, or vice-versa. The plurality of connectors may comprise L-shaped brackets, and the plurality of adjustable levelers may each comprise a threaded rod configured to adjust a height of the superstructure. Each optical floor tile of the plurality of optical floor tiles may overlap a plurality of adjacent structural panels to form a uniform surface.

The substructure may be configured to compress down from an elevated position to the floor surface to support maintenance equipment on the superstructure. In addition, a lower surface of the substructure may include a plurality of dampening plates. The substructure may have an open frame spaced apart by at least one strut, and the actuator is secured to the at least one strut.

In another aspect, a method of fabricating a dynamic floor assembly for a direct drive haptic floor system is disclosed. The method includes attaching an actuator to a substructure and attaching a plurality of bushings to the substructure. The actuator is configured to vibrate and the plurality of bushings are configured to constrain movement of the substructure in response to operation of the actuator. The method also includes attaching a respective first end of a plurality of connectors to the plurality of bushings and a respective second end to the floor surface to elevate the substructure above the floor surface. In addition, the method includes attaching a plurality of adjustable levelers extending from a top portion of the substructure to all be a same height, attaching a superstructure to the plurality of adjustable levelers, and attaching at least one structural panel on top of the superstructure forming a planar surface. The method includes removably attaching at least one optical floor tile over the at least one structural panel using magnetic forces.

The method may also include placing a plurality of the dynamic floor assemblies on the floor surface and bridging a gap between two dynamic floor assemblies with a plurality of structural bridge panels to form a direct drive haptic floor.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a front perspective view of a direct drive haptic floor system having optical floor tiles in accordance with the present disclosure;

FIG. 2 is a partial front view of the system shown in FIG. 1;

FIG. 3 is a partial cut-away top of the system shown in FIG. 1;

FIG. 4 is a perspective view of a dynamic floor assembly;

FIG. 5 is a partial view of the dynamic floor assembly and superstructure framework;

FIG. 6 is a top view of the dynamic floor assembly;

FIG. 7 is an elevational view of the dynamic floor assembly;

FIG. 8 is a top view of the dynamic floor assembly shown in different configurations;

FIG. 9 is a top view of an exemplary layout of the dynamic floor assembly;

FIG. 10 is a top view of another exemplary layout of the dynamic floor assembly;

FIG. 11 is a top view of yet another exemplary layout of the dynamic floor assembly;

FIG. 12 is a perspective view of an image being projected on the optical floor tiles;

FIG. 13 is a top view of an optical floor tile shown in FIG. 12;

FIG. 14 is an exploded detail view of the optical floor tile;

FIG. 15 is an exploded detail view of the dynamic floor assembly;

FIG. 16 is an exploded view of a bushing attachment to the substructure framework;

FIG. 17 is a front view of adjacent dynamic floor assemblies;

FIG. 18 is a front view of the dynamic floor assembly;

FIG. 19 is a front view of the dynamic floor assembly and range of vertical motion;

FIG. 20 is a side view of adjacent dynamic floor assemblies;

FIG. 21 is a side view of the dynamic floor assembly;

FIG. 22 is a side view of the dynamic floor assembly and range of vertical motion;

FIG. 23 is illustrating removing a projection tile for maintenance of the dynamic floor assembly;

FIG. 24 is a side view illustrating the dynamic floor assembly supporting maintenance equipment;

FIG. 25 is a front view illustrating the dynamic floor assembly supporting the maintenance equipment;

FIG. 26 is detail of the front view of FIG. 25; and

FIG. 27 is an elevational view showing the optical floor tiles secured to the floor surface without the dynamic floor assembly.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention is a direct drive haptic floor system developed to simulate an emotional response through vertical movement. The haptic floor system is designed to enhance a person's sensory experience. The emotional response could be fear, excitement, or joy, for example. The direct drive haptic floor system is a technical platform with endless possibilities.

A lot of what a person experiences not only comes from what is heard and seen, but also through what they feel. The haptic floor system allows a person's whole body to feel the vibrations of a rocket taking off, a volcano erupting, or the footsteps of an elephant. The haptic floor system can make a person feel these direct drive different frequencies that cannot be transmitted by sound, reaching new heights in immersive entertainment.

Benefits of the direct drive haptic floor system include that it is silent and easy to control with live audio input. In addition, the haptic floor system is scalable to different room sizes and can handle movement of large groups of people. The haptic floor system includes all the benefits of a raised floor system such as all wires and services are hidden, easy access for maintenance and able to support heavy maintenance equipment.

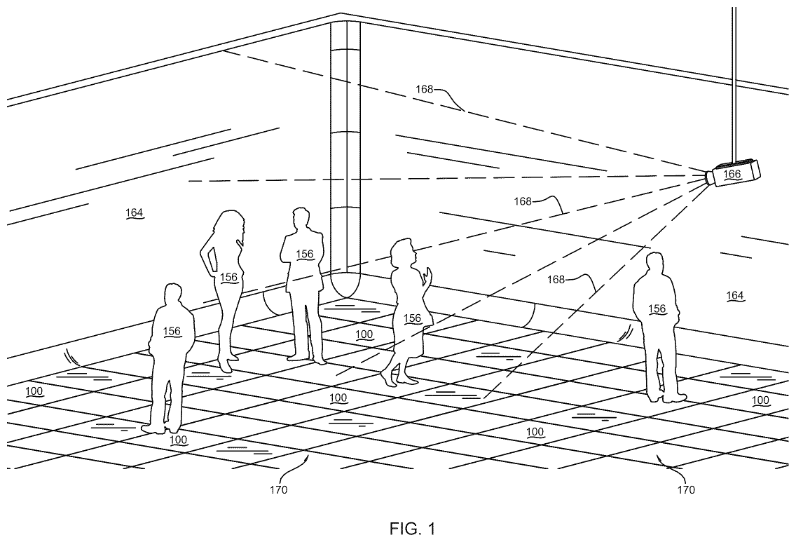

Referring now to FIG. 1, the direct drive haptic floor system of the present invention is generally designated 170, and includes a plurality of optical floor tiles 100 that together form a projection surface. A video projector 166 can be used to project images on the walls 164 and on the optical floor tiles 100 as indicated by projection lines 168. Accordingly, people 156 are provided an immersive experience that is seamless from the walls 164 to the floor.

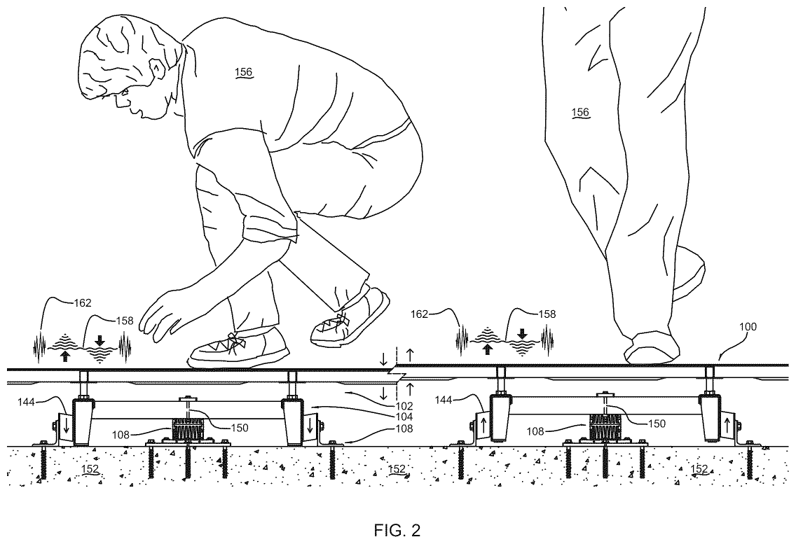

The components of the direct drive haptic floor system 170 are illustrated in FIG. 2. In particular, a dynamic floor assembly 102 is shown. The dynamic floor assembly 102 may be used in different configurations and spaced apart on a floor surface 152 to provide the desired effects as discussed in more detail below. The dynamic floor assembly 102 includes a

substructure 104 and an actuator 106 secured to the substructure 104 that is configured to vibrate. The actuator piston 150 moves vertically, which in turn causes vibrations that can be felt by the people 156 standing on the optical floor tiles 100. The vertical movement 158 may also be synchronized with audio signals 162 by sending the audio signal to the actuator 106. Typically, the projected media content 164 incorporates an audio track 162. This audio track 162 is sent via a controller to the actuator 106 in which a piston 150 moves up and down according to the audio signal 162. The body of the actuator 108 is anchored to the ground 152, so when the piston 150 moves relatively to the body of the actuator 108, it pushes and pulls the dynamic floor assembly 102 up and down. The bushings 144 support the dynamic floor assembly 102 in a way that allow to support vertical load while allowing the vertical movement 158 imposed by the piston 150 of the actuator 106. This is the basic functionality of the direct drive haptic floor system 170.

A plurality of connectors 108 are secured to the substructure 104 and configured for elevating and suspending the substructure 104 above the floor surface 152. A plurality of bushings 144 are secured between the plurality of connectors 108 and the substructure 104. The bushing 144 could comprise rubber material, a spring, or foam pads, for example. The plurality of bushings 144 are configured to constrain movement of the substructure 104 in response to operation of the actuator 106. For example, the dynamic floor assembly 102 on a left-hand side of the FIG. 2 depicts the actuator moving downwards, and the dynamic floor assembly 102 on a right-hand side of FIG. 2 depicts the respective actuator 106 moving upwards.

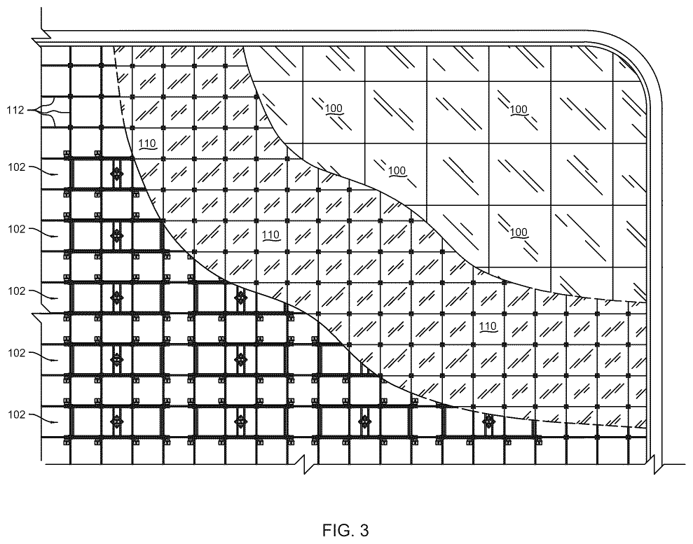

Referring now to FIG. 3, several of the dynamic floor assembly 102 can be arranged to form a larger floor surface. A particular dynamic floor assembly 102 may be directed to more than one optical floor tile 100. Accordingly, each optical floor tile 100 may not have a dedicated dynamic floor assembly 102 but the dynamic floor assemblies 102 may be spaced apart from one another as shown in FIG. 3.

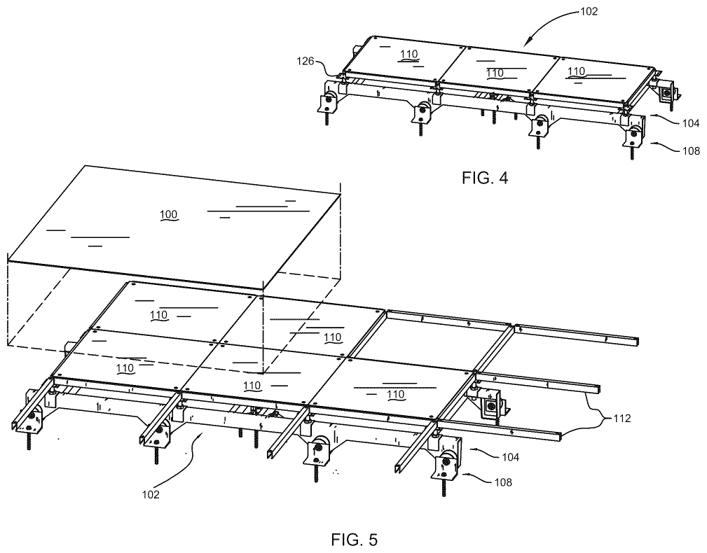

For example, the dynamic floor assembly 102 is depicted in FIGS. 4 and 5. The dynamic floor assembly 102 includes a substructure 104 such as a frame. A plurality of adjustable levelers 126 extend from a top portion of the substructure 104 and a superstructure 112 is supported by the plurality of adjustable levelers 126. A plurality of structural panels 110 are secured on top of the superstructure 112 forming a planar surface. The optical floor tile 100 is removably secured over the plurality of structural panels 110 using magnetic forces.

The dynamic floor assembly 102 is shown without the optical floor tile 100 in FIGS. 6 and 7. The connectors 108 extend from the perimeter of the substructure to provide stability. The connectors 108 and the actuator 106 may be secured to the floor surface 152 using mechanical fasteners such as screws, for example.

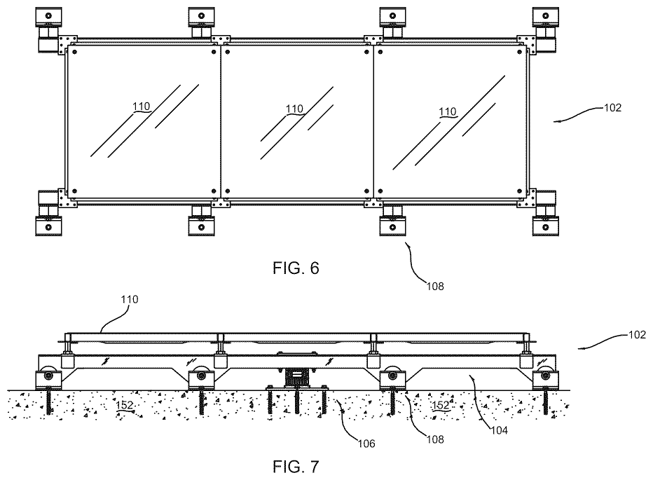

Referring now to FIG. 8, different configurations of the dynamic floor assembly 102 are depicted. For example, a first configuration 114 of the dynamic floor assembly 102 may have three structural panels 110 where the actuator 106 is positioned under the middle structural panel 110. A second configuration 116 may have two structural panels 110 with the actuator 106 under either structural panel 110. A third configuration 118 of the dynamic floor assembly 102 may have a single structural panel 100. As those of ordinary skill in the art can appreciate, the dynamic floor assembly 102 may have any number of structural panels 110 and actuators 106. The actuators 106 may be programmed and controlled wirelessly or be hardwired to a controller. The controller may be connected to a channel of an amplifier which amplifies an audio signal coming from a source. The source can be a show control system that can send a different audio signal to each channel of the amplifier so that each actuator 106 can receive its own unique signal. This attribute controls the independent dynamic motion zones from its counterpart.

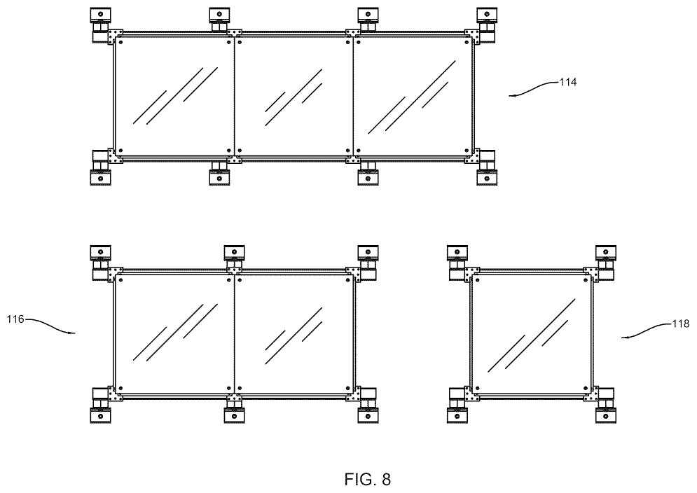

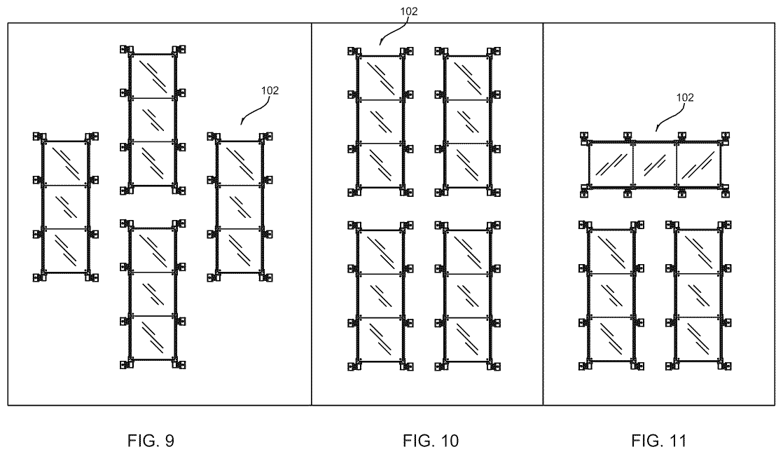

Not only can the dynamic floor assembly 102 have any desired number of structural panels 110 and actuators 106, the arrangement itself of the dynamic floor assembly 102 is also variable. For example, in FIG. 9 the dynamic floor assemblies 102 are staggered relative to one another. In contrast to the staggered arrangement, the dynamic floor assemblies 102 are aligned in FIG. 10. Yet still another arrangement is shown in FIG. 11 with two dynamic floor assemblies 102 aligned, and one is rotated ninety degrees. Accordingly, the dynamic floor assemblies 102 are modular and can be configured to fit any size and shape of floor space.

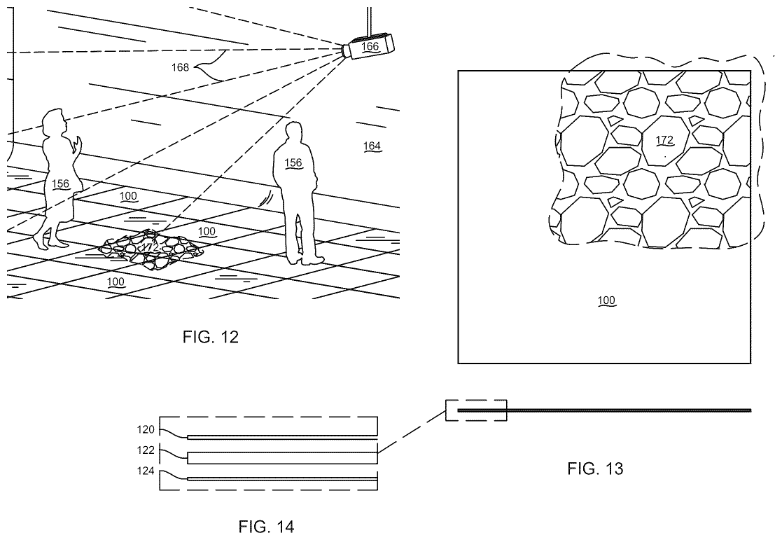

Now referring to FIGS. 12 and 13, the projector 166 is directing an image 172 on the optical floor tiles 100. For example, the projected image 172 may be an image of a stone pathway. Accordingly, as people 156 walk on the optical floor tiles 100 they see the stone walkway and the actuators 106 may be programmed to vibrate to simulate walking on a stone pathway and provide an immersive experience.

The optical floor tile 100 is shown in an exploded cross-sectional view in FIG. 14. The optical floor tile 100 may comprise three layers. For example, a first layer may comprise a top projection layer 120 which matches the optical properties of the high performance projection screen wall 164 such as: gain, color reproduction, sheen, contrast, off axis viewing etc. This is an important aspect in the art to maintain a seamless image transferring from the wall surface to the floor surface. In addition, the top layer has commercial grade wear resistant technology to conceal and protect the high-performance optical properties from standard abrasive wear, equipment and cleaning chemicals. A second intermediate layer may comprise a core layer 122 that is selected so that it is rigid enough to hide local defects of the floor but flexible enough to conform to the floor unevenness and allow the magnetic layer to be in contact with the 110 structural panels, and a third bottom layer may comprise a magnetic layer 124 such as magnetic vinyl. The layers 120, 122, 124 may all be laminated together to form the optical floor tile 100.

One object of the optical floor tile 100 being magnetic is so there is no visible fasteners on the surface of the optical floor tile 100. The optical floor tile 100 uses magnetic force to keep secured to the structural panels 110 while vibrating. The optical floor tiles 100 need to be easy to remove for access to the actuator 106 and other components. Accordingly, the optical floor tiles 100 are easy to replace in case it is damaged. In addition, the optical floor tiles 100 are interchangeable so that high-traffic areas can be replaced with optical floor tiles 100 from low-traffic areas to increase the life of the optical floor tiles 100.

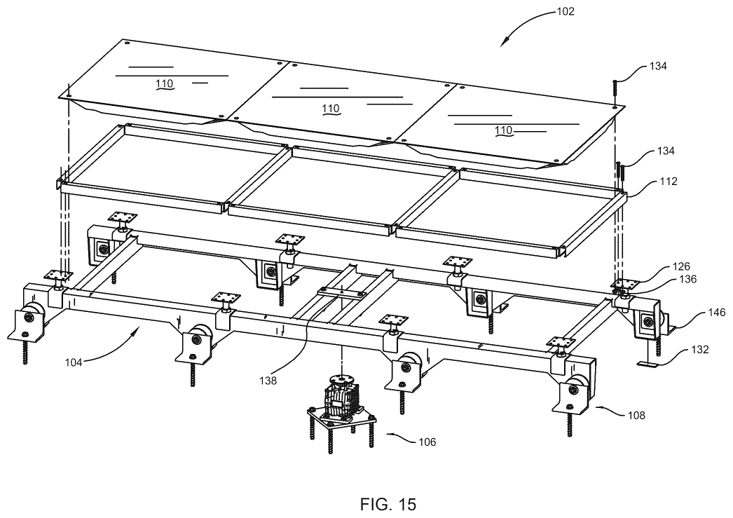

Referring now to FIG. 15, an exploded perspective view of the dynamic floor assembly is shown without the optical floor tile 100 installed. As explained above, the dynamic floor assembly 102 includes a substructure 104 that has a plurality of adjustable levelers 126. The adjustable levelers 126 may include a threaded rod 128 that can be used to adjust the height of the superstructure 112. The plurality of structural panels 110 are ferromagnetic so that the optical floor tiles 100 can be secured thereto using magnetic forces.

The plurality of connectors 108 may comprise L-shaped brackets. The substructure 104 is configured to compress down from an elevated position to the floor surface 152 to support maintenance equipment on the superstructure 112. In addition, a lower surface of the substructure 104 may include a plurality of dampening plates 132. The substructure 104 may have an open frame spaced apart by at least one strut 138, and the actuator piston 150 is secured to at least one strut 138.

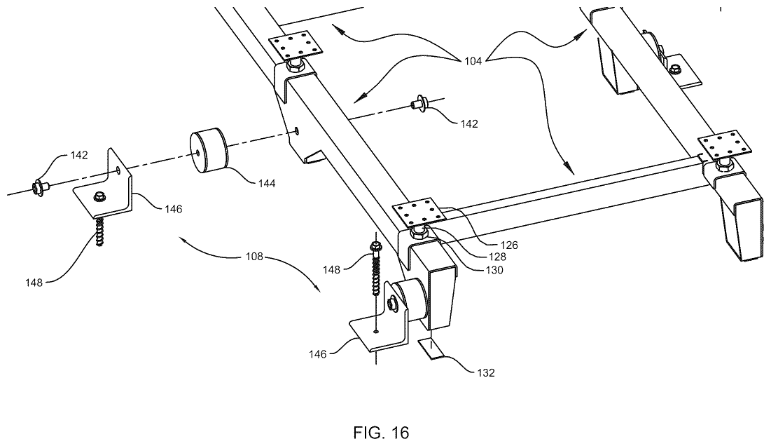

An exploded detail view of the substructure 104 is illustrated in FIG. 16. In particular, the adjustable leveler 126 is supported by the threaded rod 128, which is secured by nut 130. As discussed above the connectors 108 may be secured to the floor surface 152 using screws 148. The connectors 108 may include L-shaped brackets 146, for example. The bushings 144 are interposed between the connector 106 and the substructure 104 and secured using a mechanical fastener 142. The dampening plate 132 on a bottom surface of the substructure is the contact surface between the substructure 104 and the floor surface 152 when the superstructure 112 is supporting a load.

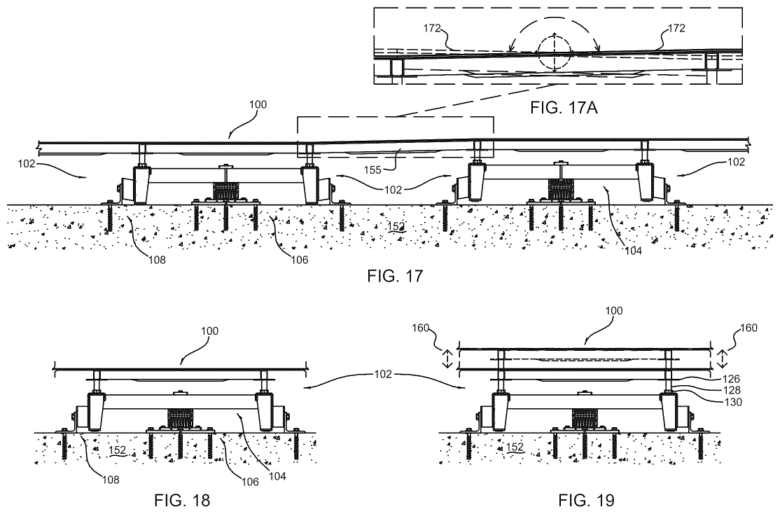

Referring now to FIG. 17, two dynamic floor assemblies 102 are shown spaced apart. A plurality of structural bridge panels 155 are configured to bridge a gap between the two independently controlled dynamic floor assemblies 102. The structural bridge panels 155 have a first edge supported by a superstructure 112 of a first dynamic floor assembly 102 and a second opposing edge supported by a second dynamic floor assembly 102. The structural bridge panels 155 tilt on a slight axis 172 as the two dynamic floor assemblies 102 move independently from one another, as shown in FIG. 17A. Each two dynamic floor assemblies 102 can move independently from its counterparts, allowing for maximum control. When the dynamic floor assembly 102 are in opposite synchronization, the structural bridge panel 155 as well as the optical floor tile 100 allows a smooth walking transition from one zone to the next. The structural bridge panel 155 is not something that is noticeable by guests, it is a smooth transition between two vibration zones.

FIGS. 18 and 19 illustrate the dynamic floor assemblies 102 without the structural bridge panels 155. In addition, FIG. 19 depicts a range of vertical motion 160 for the optical floor tile 100 using the adjustable levelers 126.

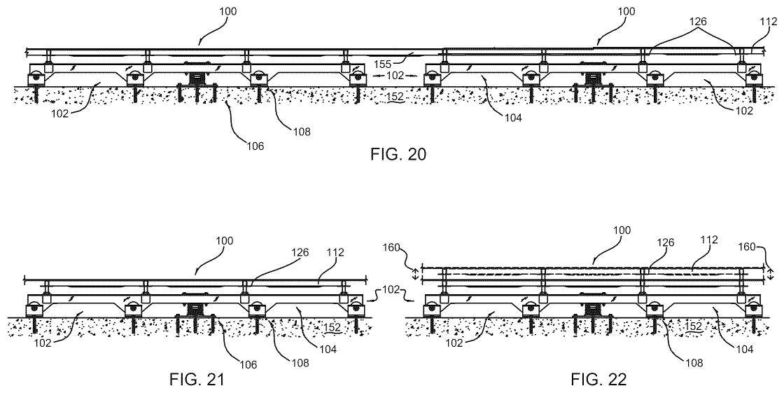

FIGS. 20-22 illustrate the dynamic floor assemblies 102 from a side view. The adjustable levelers 126 can be seen supporting the superstructure 112 above the substructure 104. Also, the connectors 108 are secured firmly into the floor surface 152 and suspend the substructure 104. The optical floor tiles 100 raise and lower with the superstructure 112 as shown in FIG. 22.

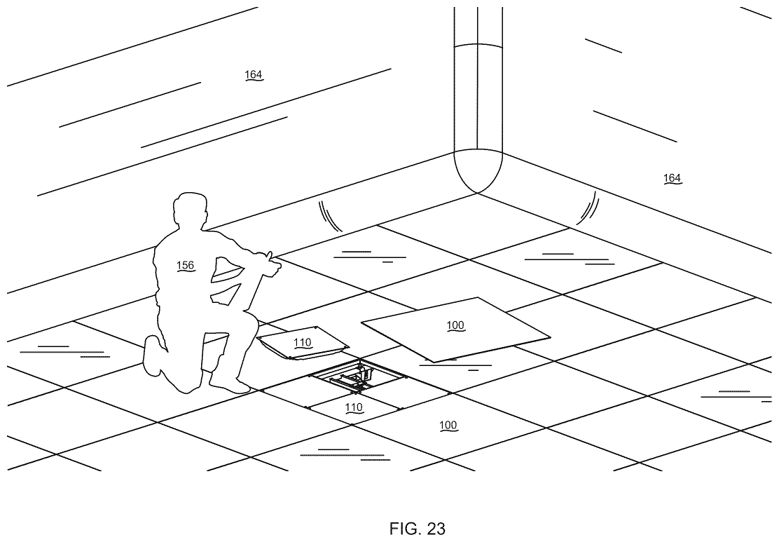

As discussed above, the optical floor tiles 100 are secured to the structural panels 110 using magnetic forces. As shown in FIG. 23, the dynamic floor assembly 102 can be easily accessed for maintenance or repair. In order to access the dynamic floor assembly 102, the optical floor tile 100 is first removed using a suction cup, for example, to expose the underlying structural panels 110. The structural panels 110 are secured to the adjustable levelers 126 of the superstructure 112 using mechanical fasteners. The mechanical fasters are removed so that the respective structural panel 110 can be removed to access the components of the dynamic floor assembly 102 for maintenance or repair.

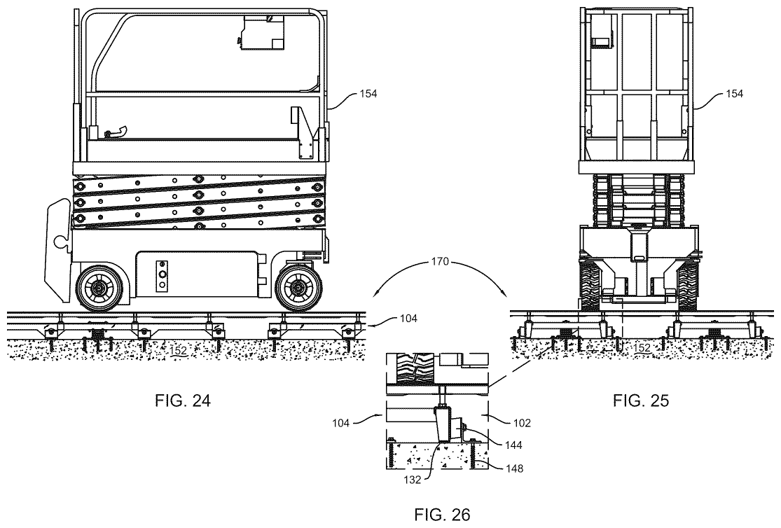

In addition, the haptic floor system 170 can support heavy maintenance equipment such as a scissor lift 154 shown in FIGS. 24-26. The bushings 144 allow the dampening plates 132 of the substructure 104 to contact the floor surface 152. Accordingly, when the equipment is on the optical floor tile 100, the load is transferred through the superstructure 112, to the substructure, 104 and to floor surface 152. Often times, this type of equipment 154 is necessary to repair or maintain a vertical projection screen that is used in conjunction with the haptic floor system 170. In addition, any floor surface can be covered with an adhesive ferromagnetic vinyl (or equivalent, like ferromagnetic paint, of metal sheet) to allow the optical floor tiles 100 to stick to it.

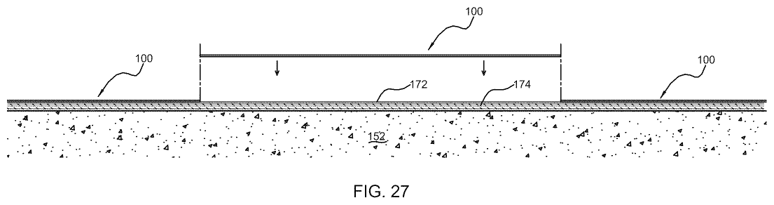

Referring now to FIG. 27, the optical floor tiles 100 are unique in that they may be secured to the floor surface 152 without the dynamic floor assemblies 102. For example, the floor surface 152 may be covered with a layer of plywood 174, along with a top ferromagnetic layer 172 adhered together and secured with anchors to the floor surface 152. The magnetic floor tiles 100 can be removably secured using magnetic forces or vice-versa. In addition, the dynamic floor assemblies 102 may be used without the optical floor tiles 100. Instead, the structural panels 110 may be covered with carpet or other flooring material and still provide the haptic functionality.

In another aspect, a method of fabricating the dynamic floor assembly 102 for a direct drive haptic floor system 170 is disclosed. The method includes attaching an actuator 106 to the substructure 104 and attaching a plurality of bushings 144 to the substructure 104. The actuator 106 is configured to vibrate and the plurality of bushings 144 are configured to constrain movement of the substructure 104 in response to operation of the actuator 106. The actuator 106 includes a piston 150. The actuator 106 is anchored to the floor surface 152, and the actuator piston 150 is pushing and pulling the substructure 104 relative to the floor surface 152. The configuration of the actuator 106 includes many benefits such as more direct response, better signal fidelity, and better low frequency strength, for example. The method also includes attaching a respective first end of a plurality of connectors 108 to the plurality of bushings 144 and a respective second end to the floor surface to elevate the substructure 104 above the floor surface 152. In addition, the method includes attaching a plurality of adjustable levelers 126 extending from a top portion of the substructure 104 to all be a same height, attaching a superstructure 112 to the plurality of adjustable levelers 126, and attaching at least one structural panel 110 on top of the superstructure 112 forming a planar surface. The method includes removably attaching at least one optical floor tile 100 over the at least one structural panel 110 using magnetic forces.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A direct drive haptic floor system, the system comprising:
a plurality of dynamic floor assemblies configured to be spaced apart on a floor surface, wherein each of the plurality of dynamic floor assemblies comprises
a substructure,
an actuator secured to the substructure and configured to vibrate,
a plurality of connectors secured to the substructure and configured for elevating the substructure above the floor surface,
a plurality of bushings secured between the plurality of connectors and the substructure, the plurality of bushings configured to constrain movement of the substructure in response to operation of the actuator,
a plurality of adjustable levelers extending from a top portion of the substructure,
a superstructure supported by the plurality of adjustable levelers,
a plurality of structural panels secured on top of the superstructure forming a planar surface, and
a plurality of optical floor tiles removably secured over the plurality of structural panels using magnetic forces.

2. The system of claim 1, further comprising a plurality of structural bridge panels bridging a gap between two dynamic floor assemblies, the plurality of structural bridge panels having a first edge supported by a superstructure of a first dynamic floor assembly and a second opposing edge supported by a second dynamic floor assembly.

3. The system of claim 1, wherein the plurality of structural panels are ferromagnetic.

4. The system of claim 1, wherein the plurality of connectors comprise L-shaped brackets.

5. The system of claim 1, wherein the plurality of adjustable levelers each comprise a threaded rod configured to adjust a height of the superstructure.

6. The system of claim 1, wherein each optical floor tile of the plurality of optical floor tiles overlaps a plurality of adjacent structural panels.

7. The system of claim 1, wherein the substructure is configured to compress down from an elevated position to the floor surface to support maintenance equipment on the superstructure.

8. The system of claim 1, wherein a lower surface of the substructure further comprises a plurality of dampening plates.

9. The system of claim 1, wherein each optical floor tile of the plurality of optical floor tiles comprises a top projection layer, a core layer, and a magnetic layer laminated together.

10. The system of claim 1, wherein the substructure comprises an open frame spaced apart by at least one strut, and the actuator is secured to the at least one strut.

11. A dynamic floor assembly comprising:
a substructure;
an actuator secured to the substructure and configured to vibrate;
a plurality of connectors secured to the substructure and configured for elevating the substructure above the floor surface;
a plurality of bushings secured between the plurality of connectors and the substructure, the plurality of bushings configured to constrain movement of the substructure in response to operation of the actuator;
a plurality of adjustable levelers extending from a top portion of the substructure;
a superstructure supported by the plurality of adjustable levelers;
a plurality of structural panels secured on top of the superstructure forming a planar surface; and
at least one optical floor tile removably secured over the plurality of structural panels using magnetic forces.

12. The assembly of claim 11, further comprising a plurality of structural bridge panels configured to bridge a gap between two dynamic floor assemblies.

13. The assembly of claim 11, wherein the plurality of structural panels are ferromagnetic.

14. The assembly of claim 11, wherein the plurality of connectors comprise L-shaped brackets.

15. The assembly of claim 11, wherein the plurality of adjustable levelers each comprise a threaded rod configured to adjust a height of the superstructure.

16. The system of claim 11, wherein the at least one optical floor tile comprises a top projection layer, a core layer, and a magnetic layer laminated together.

17. A method of fabricating a dynamic floor assembly for a direct drive haptic floor system, the method comprising:
attaching a first end of an actuator to a substructure, and a second end of the actuator to a stationary surface, wherein the actuator is configured to vibrate;
attaching a plurality of bushings to the substructure, wherein the plurality of bushings are configured to constrain movement of the substructure in response to operation of the actuator;
attaching a respective first end of a plurality of connectors to the plurality of bushings and a respective second end to the floor surface to elevate the substructure above the floor surface;
attaching a plurality of adjustable levelers extending from a top portion of the substructure to all be a same height;
attaching a superstructure to the plurality of adjustable levelers;
attaching at least one structural panel on top of the superstructure forming a planar surface; and
removably attaching at least one optical floor tile over the at least one structural panel using magnetic forces.

18. The method of claim 17, further comprising placing a plurality of the dynamic floor assemblies on the floor surface and bridging a gap between two dynamic floor assemblies with a plurality of structural bridge panels to form a direct drive haptic floor.

19. The method of claim 18, wherein the at least one structural panel is ferromagnetic.

20. The method of claim 19, wherein the at least one optical floor tile comprises a top projection layer, a core layer, and a magnetic layer laminated together.

21. A direct drive haptic floor system, the system comprising:
a plurality of dynamic floor assemblies configured to be spaced apart on a floor surface, wherein each of the plurality of dynamic floor assemblies comprises
a substructure,
an actuator secured to the substructure and configured to vibrate,
a plurality of connectors secured to the substructure and configured for elevating the substructure above the floor surface,
a plurality of bushings secured between the plurality of connectors and the substructure, the plurality of bushings configured to constrain movement of the substructure in response to operation of the actuator,
a plurality of adjustable levelers extending from a top portion of the substructure,
a structural panel secured on top of the plurality of adjustable levelers forming a planar surface, and
a flooring material secured over the structural panel using magnetic forces.

22. An optical flooring tile comprising:
a top projection layer;
a core layer; and
a magnetic layer;
wherein the top projection layer, the core layer, and the magnetic layer are laminated together and the optical flooring tile is configured to be secured to a ferromagnetic flooring surface.
